(19) United States
(12) Patent Application Publication
(10) Pub. No.: US 2025/0356128 A1
(43) Pub. Date: Nov. 20, 2025

(54) Conversion from device documentation to technical specifications

(71) Applicant: NATIONAL INSTRUMENTS CORPORATION, Austin, TX (US)

(72) Inventors: Sebastien Savard-Rosas, Austin, TX (US); Andrew Philip Dove, Austin, TX (US); Stephen Thung, Norman, OK (US)

(21) Appl. No.: 19/210,524

(22) Filed: May 16, 2025

Related U.S. Application Data
(60) Provisional application No. 63/648,742, filed on May 17, 2024.

(51) Int. Cl. G06F 40/289; G06F 40/103

(52) U.S. Cl. CPC G06F 40/289; G06F 40/103

(57) ABSTRACT

Apparatuses, systems, and methods for one or more models (e.g., generative Artificial Intelligence (AI) and/or large language model(s)) to determine technical specifications based on input documentation of a device under test (DUT). The model(s) may divide the documentation into portions, iteratively identify technical specifications in the portions, format the specifications, and/or identify duplicative or related specifications for removal or consolidation.

### PRIORITY CLAIM

This application claims benefit of priority to provisional application No. 63/648,742 entitled “Conversion from device documentation to technical specifications”, filed on May 17, 2024, whose disclosure is hereby incorporated by reference in its entirety as though fully and completely set forth herein.

### TECHNICAL FIELD

The invention relates to test process development, and more particularly to apparatuses, systems, and methods for model (e.g., generative Artificial Intelligence (AI)) assisted technical specification development.

### DESCRIPTION OF THE RELATED ART

Currently, there are a variety of tools to support a test engineer in test process development when given documentation of a DUT. For example, there are tools to aid a test engineer in the front-end of life cycle of a test process, e.g., such as tools to match tests to instruments. Further, there are tools to aid a test engineer in the back-end of the life cycle of the test process, e.g., such as tools that provide measurement abstraction. In addition, there are various tools that provide high-level test support as well as tools that can generate test sequences based on detailed inputs from the test engineer.

However, a test engineer may need to work/interact with many, disparate software systems to leverage these various tools to develop the test process for the DUT. For example, in various aspects of development of the test process, a test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each role/tool may require its own expertise and resource, leading to high overhead costs in time, training, and expertise develop. These high overhead costs may then extend time to market for particular products. This may apply to multiple products (e.g., with different design documentations). Therefore, improvements are desirable.

### SUMMARY

Embodiments described herein relate to computing systems, memory media, and methods for model (e.g., generative Artificial Intelligence (AI)) assisted technical specification development, e.g., using a generative AI based system to produce test cases based on an initial input of documentation of a device under test (DUT) and/or to refine the documentation as testing is performed.

For example, a description and/or other documentation of a DUT may be inputted (e.g., using various formats such as word processing documents, Portable Document Format (PDF) documents, spreadsheets, presentation documents, three-dimensional (3D) models, two-dimensional (2D) models, images, videos, and/or other multimedia recordings, among other file types and/or formats) into one or more model(s), e.g., such as one or more large language models (LLMs). The model(s) may then analyze the documents and generate (e.g., extract) a technical description of the DUT (e.g., one or more DUT specifications) based on the documents.

Note that the techniques described herein may be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting a technical specification generation platform, according to some embodiments.

FIG. 4 illustrates a block diagram of an example of a process for model supported DUT specification development and application, according to some embodiments.

FIG. 5 illustrates a block diagram of an example of a method DUT specification development, according to some embodiments.

FIG. 6 illustrates a block diagram of an example of a method for generating a DUT specification, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
AI: Artificial Intelligence
LLM: Large Language Model
DUT: Device Under Test
UUT: Unit Under Test
VI: Virtual Instrument
GUI: Graphical User Interface

### Terms

The following is a glossary of terms used in this disclosure:

Device Under Test (DUT) or Unit Under Test (UUT)—A physical device or component that is being tested.

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, where the plurality of interconnected nodes or icons visually indicate functionality of the program. May also be referred to as a Virtual Instrument (VI).

Data Flow Graphical Program (or Data Flow Diagram)—A graphical program or diagram comprising a plurality of interconnected nodes, wherein the connections between the nodes indicate that data produced by one node is used by another node. May also be referred to as a Virtual Instrument (VI).

Graphical User Interface—this term is intended to have the full breadth of its ordinary meaning. The term “graphical user interface” is often abbreviated to “GUI”. A GUI may comprise only one or more input GUI elements, only one or more output GUI elements, or both input and output GUI elements. May also be referred to as a Virtual Instrument (VI).

The following provides examples of various aspects of GUIs. The following examples and discussion are not intended to limit the ordinary meaning of GUI, but rather provide examples of what the term “graphical user interface” encompasses:

A GUI may comprise a single window, panel, or dialog box having one or more GUI Elements, or may comprise a plurality of individual GUI Elements (or individual windows each having one or more GUI Elements), wherein the individual GUI Elements or windows may optionally be tiled together.

Graphical User Interface Element—an element of a graphical user interface, such as for providing input or displaying output. Exemplary graphical user interface elements include input controls and output indicators.

Input Control—a graphical user interface element for providing user input to a program. Exemplary input controls include buttons, check boxes, input text boxes, knobs, sliders, etc.

Output Indicator—a graphical user interface element for displaying output from a program. Exemplary output indicators include charts, graphs, gauges, output text boxes, numeric displays, etc. An output indicator is sometimes referred to as an “output control”.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

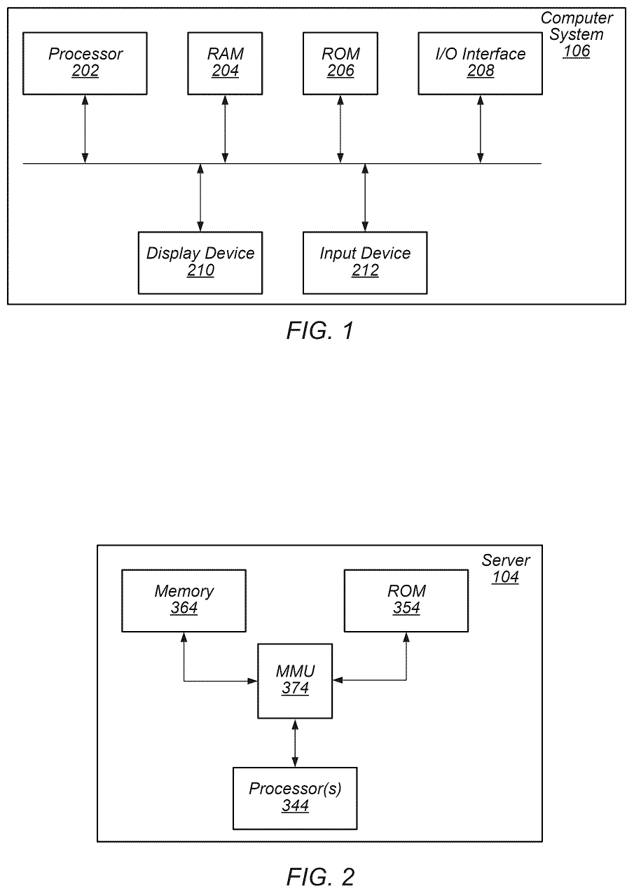

### FIG. 1: Computer System

FIG. 1 illustrates a computer system 106 that may include a processor 202, random access memory (RAM) 204, nonvolatile memory 206, a display device 210, an input device 212 and an I/O interface 208 for coupling to sensors. For example, the computer system 106 may include hardware and software components for implementing or supporting implementation of features described herein. The processor 202 may be configured to implement or support implementation of part or all of the methods described herein, e.g., by executing program instructions stored on a memory medium (e.g., a non-transitory computer-readable memory medium). Alternatively, the processor 202 may be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 may be configured to implement or support implementation of part or all of the features described herein. For example, the computer system 106 may be configured to operate or call one or more model, e.g., to generate requirements from a DUT documentation, generate test cases, etc.

In addition, as described herein, processor(s) 202 may be comprised of one or more processing elements. In other words, one or more processing elements may be included in processor(s) 202. Thus, processor(s) 202 may include one or more integrated circuits (ICs) that are configured to perform the functions of processor(s) 202. In addition, each integrated circuit may include circuitry (e.g., first circuitry, second circuitry, etc.) configured to perform the functions of processor(s) 202.

As shown, the computer system 106 may include a processor that is coupled to a random access memory (RAM) and a nonvolatile memory. The computer system 106 may also include user interface elements for receiving user input and a display device for presenting output. For example, the user interface elements may include any of various elements, such as a display (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input. The computer system 106 may also include an Input/Output (I/O) interface that may be communicatively coupled (e.g., locally via a system bus, or remotely via a network and/or serial interface) to various hardware elements (e.g., such as FPGAs, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as computer system 106, access to one or more models (e.g., such as one or more LLMs), such as a generative AI, e.g., as further described herein.

In some embodiments, the server 104 may access via a radio access network, such as a 5G New Radio (5G NR) radio access network. In some embodiments, the server 104 may be access via a local area network (LAN), e.g., via an ethernet and/or Wi-Fi connection.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

### Documentation to Test Cases/Technical Specification

Currently, a test engineer may need to work/interact with many, disparate software systems to leverage various tools to develop a test process for a DUT. Different DUTs may have different DUT documentation, each of which may include different types of information and/or be formatted in different ways. Thus, the current test engineer needs to not only understand the DUT to design the test process and be versed in a vast array of tools, but also to review in detail the relevant DUT documentation(s). In various aspects of development of the test process, the test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each of these roles/tools require independent expertise and resources, leading to high overhead costs in time, training, and expertise develop. These high overhead costs may then extend time to market for particular products, particularly with different DUT documentations. Therefore, improvements are desirable.

Embodiments described herein provide systems, methods, and mechanisms for a model (such as generative Artificial Intelligence (AI)) assisted test case development and/or DUT documentation refinement process. For example, one or more models (e.g., such as one or more LLMs) may develop test cases (e.g., requirements) based on an initial input of a DUT documentation of a device under test (DUT). For example, a description and/or specification (e.g., collectively, DUT documentation) of a DUT may be inputted (e.g., using various formats such as word processing documents, Portable Document Format (PDF) documents, spreadsheets, presentation documents, three-dimensional (3D) models, two-dimensional (2D) models, images, videos, and/or other multimedia recordings, as well as programming code, schematics, layouts, designs, bill of materials, and/or other engineer formats) into one or more models (e.g., such as one or more LLMs) executing on one or more computer system, such as computer system 106, and/or one or more server, such as server 104. The model(s) may summarize (e.g., consume, process, and/or analyze) the documents and generate a description of the DUT based on the DUT documentation document(s).

In some embodiments, the model(s) may query (e.g., via an interactive question/answer session) the end user regarding the DUT. For example, the model(s) may query the end user to clarify what the end user and/or document(s) mean. In other words, the model(s) may not only consider input DUT documentation, but also ask for clarification from the end user.

In some instances, the model(s) may be interacted with via a “chat box” in which documents (e.g., word processing documents, Portable Document Format (PDF) documents, spreadsheets, presentation documents, three-dimensional (3D) models, two-dimensional (2D) models, images, videos, and/or other multimedia recordings as well as Virtual Instruments (Vis)) can be directly “dropped” into the chat box for the model(s) to consume. In addition, the model(s) may display, e.g., via the chat box, pinout diagrams, wiring tables/diagrams, VI diagrams, live data tables from tests being performed, and/or other displays of live data from test being performed.

In some instances, the model(s) may guide a user from DUT documentation to test. For example, the model(s) may aid and/or develop a test plan based on the DUT documentation. In addition, the model(s) may generate programming code, e.g., based on LabVIEW™, Python, MeasurementLink, C++, MATLAB™, and so forth. Further, the model(s) may generate TestStand™ sequences, operator manuals, calibration codes and/or intervals, and so forth. In this manner, the model(s) may support a specification to test (Spec to Test) platform. Additionally, the model(s) may produce and/or generate all assets needed to run, deploy, debug, and/or maintain a test system and corresponding tests.

In some embodiments, one or more models may be used to ingest (e.g., AI-powered ingestion) customer DUT documentation (e.g., product specification in PDF and/or other formats) and generate DUT specifications. For example, the generated DUT specifications may be or include guaranteed and/or typical specifications/parameters along with the operating conditions at which these parameters are guaranteed/expected to be upheld. The generated DUT specification data may be ingested into an application such as the NI Specification Compliance Manager.

In some embodiments, an automated test generation framework may automatically define and configure test/measurement sequences based on the generated DUT specification data. This may involve automatic use of the generated specifications to define pass/fail criteria for ongoing tests. Once sequences are defined, the application may provide a user the ability to automatically execute measurements on the DUT(s) to validate that the DUT(s) is in compliance with the provided DUT documentation.

In some embodiments, measurement data from any automatically executed tests may act as a feedback mechanism into the DUT product development life cycle. This may aid the user towards refining both the DUT and the claimed DUT documentations over time. An integral part of this ongoing feedback mechanism may be through (e.g., AI powered) automated data analysis tools in the one or more models. For example, the one or more models may compare the guaranteed vs typical performance and detect/analyze any deviations or anomalies. For example, the one or more models may provide analysis so that users can (e.g., regularly) update the DUT specifications based on the data gathered from these automated measurements and analysis. For example, the one or more models may make automated insights and suggestions, such as widening claimed operating condition ranges or modifying performance claims under particular conditions.

In some embodiments, the one or more models may include a large language model (LLM) to generate structured data from text. The LLM may be used to interpret, generate, and synthesize key details from text. For example, this generation may accelerate research and development operations in the test and measurement domain. In one example, the one or more models may perform the generation of a semiconductor product's guaranteed and typical specifications along with the operating conditions at which these parameters are guaranteed and expected to be upheld.

Note that this generation can be done with cloud models and/or local models. LLMs and/or embedding models may be used, among various possible types of AI and/or non-AI models. There currently exists a tangible tradeoff in terms of intelligence and security that should be referred to when making this decision about local vs cloud models.

In some embodiments, the methods described herein may accelerate the ability of organizations in various disciplines to establish and abide by a specification-driven automation workflow.

In some embodiments, the one or more models may generate strict definitions of product specifications from plain language (e.g., English, German, Chinese, Japanese, etc.) and transform them into formatted specifications that describe how a new product (e.g., DUT) needs to function. This formatted information may be automatically ingested into an application such as NI's Specification Compliance Manager software, which may act as the springboard towards an automated test generation framework and lifecycle.

In some embodiments, the presence of the user's DUT (e.g., semiconductor product, or other product, etc.) in NI Specification Compliance Manager or similar software may allow the organization to automatically define and configure tests against the product's specifications. For example, this may involve automatic use of the product specifications to define pass/fail criteria for ongoing tests. As the user uses this framework to automatically execute tests/measurements on the product, results of the subsequent testing may serve as a feedback mechanism into the DUT product development life cycle. The user may be presented with automatic insights in various forms that may shape various choices in product development.

In some embodiments, in order to generate specifications from an organization's product documents, the one or more models may divide the documents into portions (e.g., pages or other size portions) and may iterate over each portion of the document(s). For example, one model, such as an LLM may be called with a prompt template which gives specific instructions on how to generate requirements. In some embodiments, the one or more models may design the prompt based on aspects of the document contents. In some embodiments, the one or more models may also consider as instructions how to output the requirements in a structured format. For example, a JSON string format may be used, as one possibility.

In some embodiments, the one or more models may use or include a parser such as Langchain's Pydantic output parser to generate the output format instructions. The one or more models may create a Pydantic object model that matches the expected object structure that the application (e.g., NI Specification Compliance Management API) expects.

In some embodiments, as the one or more models iterate through the portions, the one or more models may also keep track of metadata for each generated requirement. For example, the metadata may include the location (e.g., source (filename) and page number).

In some embodiments, these model (e.g., LLM) calls can be done in parallel. Note that by running specification generation on a portion (e.g., page-by-page) basis, the one or more models may acquire awareness of the source location(s) of the specification. In some embodiments, the one or more models may reduce the number of model calls and tokens used by generating requirements on more than one page at a time (e.g., using larger portions), but this may complicate keeping track of the requirements' locations and/or other metadata.

In some embodiments, the one or more models may include or employ an intelligent text-chunking method in order to group together and isolate information that pertains to the same specification of interest. For example, such text-chunking may be used to divide the documents into relevant portions.

In some instances, there may be some overarching information (like specification conditions) that are stated once or a few times in the specification documents, and which apply towards many specifications throughout the DUT documentation. In order to address this possibility, the one or more models may make several passes through all of the DUT documentation content in order to generate product-wide information that applies to each or specific specifications. For example, one pass may be made by at least one of the one or more models to identify any overarching information (e.g., a design temperature range, etc.) that may apply to all of (or a subset of) the generated specifications. The one or more models may keep track of this overarching information and synthesize it with more granular and specification-specific information when populating the application such as the NI Specification Compliance Manager.

In some embodiments, a first model of the one or more models may be used for portioning the DUT documentation, a second model of the one or more models may be used for generating specifications from each portion of the DUT documentation, and a third model of the one or more models may be used for identifying and generating overarching information.

In some embodiments, the one or more models may determine if it is appropriate to combine any specifications that the generation process has identified. For example, such combination/consolidation could be appropriate if specific specifications are mentioned in multiple places in the DUT documentation. For example, such specifications may be repeated with more/different detail or caveats in multiple places within the DUT documentation. As one possibility, the one or more models may include an embedding model and the one or more models may generate embedding vectors on the output (e.g., JSON string) of each enumerated specification. This process may capture the semantic meaning of the DUT documentation. Further, the one or more models may use vector similarity techniques like cosine similarity to distinguish similar specification enumerations from different ones. For example, the one or more models may filter out specification strings whose vector embeddings have a similarity score that passes a certain threshold (say 0.99, as one possibility). In other words, if multiple requirements are very similar, the one or more models may only keep one of them.

In some embodiments, the one or more models may assign each specification string to a cluster. For example, this may be done after the specifications are generated, according to some embodiments. To do this clustering, the one or more models may perform a preprocessing step to boost the performance of density-based clustering. For example, UMAP may be an effective preprocessing step. This preprocessing may reduce the dimensionality of the (e.g., high dimensionality) embeddings. The one or more models may then assign each specification string to clusters of similar specifications. For example, the one or more models may use a hierarchical clustering algorithm (e.g., such as HBDSCAN) to perform the clustering. Next, the one or more models may use a model (e.g., an LLM) to determine how many separate specifications actually exist in each cluster. Then the one or more models may subsequently reduce the specifications in each cluster of similar specifications into a more consolidated collection of specifications. For example, the one or more models may map a system prompt which instructs how to do this reduction over each cluster of specifications in parallel. For example, one of the one or more models (e.g., an LLM) may use a prompt to reduce the specifications in a cluster, e.g., by eliminating redundant specifications and/or combining related specifications, among various possibilities.

In some embodiments, after the one or more models have generated specifications in the correct (e.g., JSON) format that the application (e.g., the NI Specification Compliance Manager API) defines, the one or more models may trigger API call(s) to upload the specifications to the user's application (e.g., NI Specification Compliance Manager) for the DUT.

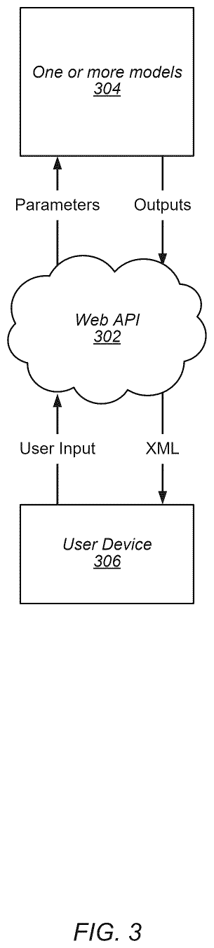

FIG. 3 illustrates an example of a system supporting a technical specification generation platform, according to some embodiments. As shown, the system may include a user device 306, e.g., which may be a computer system 106 that provides an interface with one or more models 304 (e.g., which may be hosted on a server or servers, such as server 104) via a web Application Programming Interface (API) 302. In at least some instances, the one or more models 304 may be one or more large language models (LLMs) 304 and/or an LLM 304. The interface may allow the model(s) to interact with (e.g., communicate with) local hardware either on the user device and/or in communication with the user device. In addition, the interface may allow the model(s) to interact with local software resources (e.g., such as programming platforms (e.g., LabVIEW™, Python, MeasurementLink, C++, MATLAB™, and so forth). Thus, as shown, a user may interact with the model(s) 304 via web API 302 using the user device 306. The user device 306 may execute one or more software resources as well as host hardware (e.g., such as data acquisition boards, control boards, vision boards, and the like) and/or communicate with remote hardware (e.g., such as data acquisition boards, control boards, vision boards, and the like). The user device 306 may provide user inputs, including DUT documentation and/or information regarding available hardware and/or software resources to the web API 302. The web API 302 may convert the user inputs to model parameters/inputs and/or the web API 302 may generate model parameters/inputs based on the user inputs. The model parameters may be used by the model(s) 304 to generate and/or produce model outputs that are returned to the web API 302. The web API 302 may then convert the model outputs to Extensible Markup Language (XML) and/or generate XML based on the model outputs. For example, the model outputs may include programming code (e.g., such as graphical programming code) that may be converted (e.g., serialized) to Large Language Model (LLM) optimized XML, JavaScript Object Notation (JSON), and/or a Domain Specific Language (DSL). The XML may then be delivered to the user device 306 as natural language output to an end user. In this manner, the model(s) may interact with the end user to generate test cases and/or DUT specifications input DUT documentation. Note further, that aspects of the model(s) may include a user interface executing on the user device 306 as well as background software to discover and maintain hardware information as well as to discover and maintain connections with local applications, the web API 302 to allow the user device 306 to interact with the model(s) 304, and the model(s) 304 that may be executing on the server(s) remote from the user (e.g., the model(s) 304 may be cloud based).

In addition, as noted above, in some instances, the model(s) may generate and/or produce documents such as test case definitions, test system configurations, assembly procedures, operational procedures, and/or calibration procedures. These documents may be based on and/or adapted from existing documents (e.g., DUT documentation). Additionally, the model(s) may summarize long documents to case end user consumption and/or generate coverage certification documents.

Further, as noted above, in some instances, the model(s) may perform or aid in test case development. For example, the model(s) may identify “corner cases” (e.g., edge of envelop testing conditions).

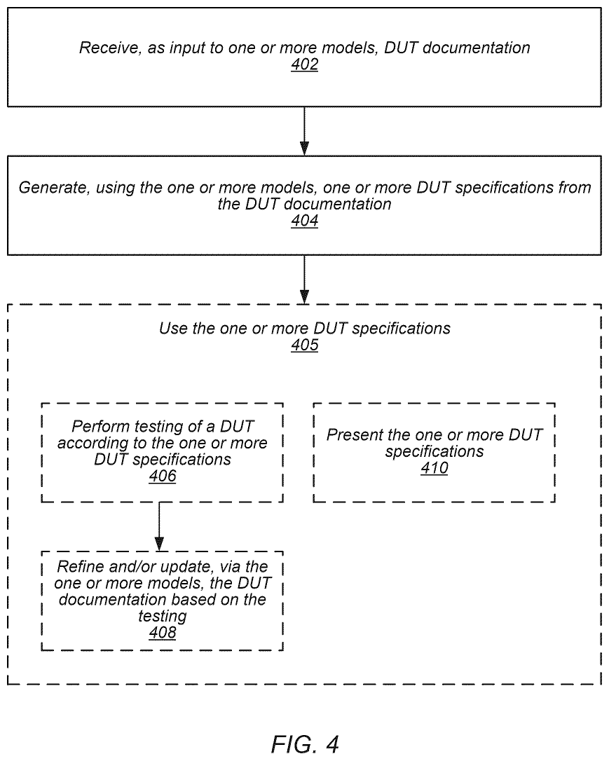

FIG. 4 illustrates a block diagram of an example of a process for conversion of DUT documentation to test cases (e.g., DUT technical specification(s)), according to some embodiments. The process shown in FIG. 4 may be used in conjunction with any of the systems, methods, or devices shown in the Figures, among other devices. In various embodiments, some of the process elements shown may be performed concurrently, in a different order than shown, or may be omitted. Additional process elements may also be performed as desired. As shown, this process may operate as follows.

At 402, device under test (DUT) documentation may be received as input to one or more models 304, according to some embodiments.

In some embodiments, the DUT documentation may be received via a user interface. The user interface may be chat box based, among various possibilities.

The DUT documentation may take one (or a combination) of many forms. The DUT documentation may be in any language(s) and may include plain language and/or technical language, among various possibilities. For example, the DUT documentation may include any, any combination of, and/or all of a database including information specifying the DUT, a computer generated (e.g., virtual) model (e.g., including both 2D and/or 3D models as well as software models) of the DUT specifying information associated with the DUT, PDF-based documentation, spreadsheet-based documentation, word processor-based documentation, images (e.g., single images and/or streams of images), PIN-out diagrams, performance data, programming code (e.g., such as C/C++, C#, Python, Ruby, Rust, BASIC, FORTRAN, VHDL, and/or Verilog code, among other programming codes), schematics, layouts, designs, bill of materials (BOM), emails, chats, audio recordings, video recordings, engineering formats (e.g., comma-separated values (CVS) files, Extensible Markup Language (XML) files, JavaScript Object Notation (JSON) files, MATLAB Data File format (MAT) files, Technical Data Management Streaming (TDMS) files, Hierarchical Data Format version 5 (HDF5) files, a drawing format (DWG) files, a 3D printing format (STL) file, Standard for the Exchange of Product (STEP) model data file, Initial Graphics Exchange Specification (IGES) file, a G-code (a numerical control (NC) programming language used for CNC machining) file, a Printed Circuit Board (PCF) file format such as Gerber (RS-274X) and/or ODB++, a SIMULINK Model file, an ASCII STL format file, a Building Information Modeling (BIM) file, such as Industry Foundation Classes (IFC) for interoperability in construction projects, a Standard Test Data Format (STDF) file, an Automatic Test Description Format (ATDF) file, a Boundary Scan Description Language (BSDL) file, a VHDL/Verilog file (e.g., hardware description languages often used for writing test benches and simulation models for semiconductor devices), a Waveform Generation Language (WGL) file (e.g., utilized for specifying digital test patterns to test vector-based semiconductor devices, a Test Description Language (TDL) file, a Graphic Data System II (GDSII) file, a Test Access Port (TAP) file (e.g., a standard for accessing embedded test and debug features of semiconductor devices), and/or a DAT file (e.g., a generic format used to store various types of test data, such as waveform or parametric test results, among other types of engineering formats), and/or other forms of documentation. Thus, the input of the DUT specification to the process may take the form of word processing documents, PDF documents, spreadsheets, presentation documents, 3D models, 2D models, images, videos, and/or other multimedia recordings.

In some embodiments, the DUT documentation may include at least one of (e.g., one or more of, a plurality of, and/or all of) a database including information specifying the DUT, a virtual two-dimensional model of the DUT, a virtual three-dimensional model of the DUT, a software model of the DUT, a portable document format (PDF)-based document, a spreadsheet-based document, a word processor-based document, a presentation-based document, one or more images of the DUT, one or more videos of the DUT, a diagram of the DUT, performance data associated with the DUT, programming code, an engineering format-based file or document, a schematic of the DUT, a schematic associated with the DUT, a layout of the DUT, a layout associated with the DUT, a design of the DUT, a design associated with the DUT, a bill of materials (BOM) associated with the DUT, emails associated with and/or referring to the DUT and/or an aspect of the DUT, a chat transcript associated with and/or referring to the DUT and/or an aspect of the DUT, an audio recording associated with and/or referring to the DUT and/or an aspect of the DUT, and/or a video recording associated with and/or referring to the DUT and/or an aspect of the DUT.

At 404, the model(s) may generate one or more DUT specifications (e.g., performance parameter, test case, etc.) from the DUT documentation. For example, the one or more models may consume (e.g., process and/or analyze) the DUT documentation and may generate (e.g., extract and/or identify) hardware requirements and/or software requirements. The DUT specification(s) may be machine-readable. In other words, the model(s) may generate/develop/design machine-readable hardware requirements and/or machine-readable software requirements based on consumption (e.g., processing and/or analyzing) of the DUT documentation. For example, the model(s) may extract technical specification(s) of the DUT based on plain language of the documentation.

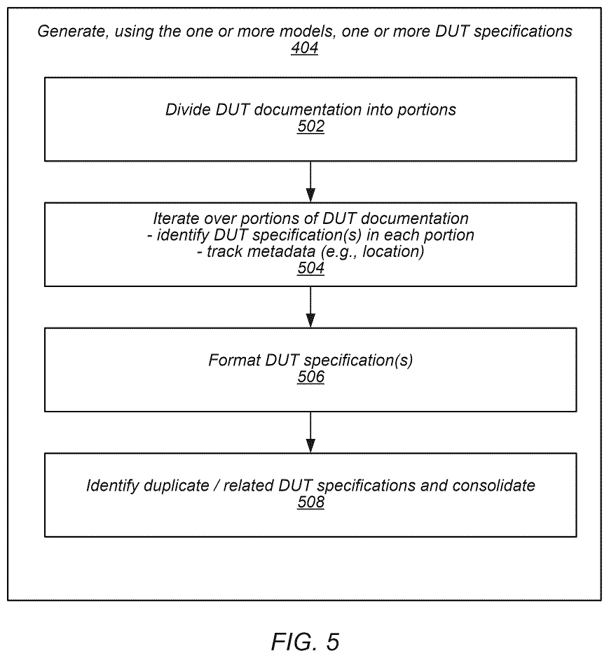

More detail about one possible approach to performing the generation (404) is illustrated in FIG. 5 and discussed further below. Other approaches may be used as desired.

Optionally, at 405, the one or more models may use DUT specification(s) in any of various ways, according to some embodiments. Example uses of the generated DUT specification(s) are shown at 406, 408, and 410. Other uses may be performed as desired.

For example, at 406, testing may be performed on the DUT. For example, an automated test generation framework may automatically define and configure test/measurement sequences based on the generated DUT specification data, according to some embodiments. This may involve automatic use of the generated specifications to define pass/fail criteria for ongoing tests. Once sequences are defined, the application may provide a user the ability to automatically execute measurements on the DUT(s) to validate that the DUT(s) is in compliance with the provided DUT documentation. For example, an application such as NI Specification Compliance Manager may be used to evaluate compliance.

At 408, the one or more models may generate refinement and/or updates to the DUT documentation based on any testing performed (e.g., in 406), according to some embodiments. For example, the one or more models may provide suggestions to the user to broaden or narrow performance claims and/or operating conditions. For example, the suggestions may include changes to speeds, beamforming abilities, acceptable conditions (temperature, humidity, etc.), power requirements, or any of various capabilities, requirements, etc.

Similarly, the one or more models may generate feedback for DUT product development. For example, results of the testing may serve as a feedback mechanism into the DUT product development life cycle. The model(s) may generate and present automatic insights in various forms that shape various choices in product development.

As another example, at 410, the one or more models may display the generated specification(s) to the user, according to some embodiments. For example, a summary of the specification(s) may be presented via API 302 and user device 306.

FIG. 5 illustrates a block diagram of an example of a process for conversion of DUT documentation to test cases (e.g., DUT specification(s)), according to some embodiments. For example, the process of FIG. 5 may be an example of 404 as discussed above with respect to FIG. 4. The process shown in FIG. 5 may be used in conjunction with any of the systems, methods, or devices shown in the Figures, among other devices. In various embodiments, some of the process elements shown may be performed concurrently, in a different order than shown, or may be omitted. Additional process elements may also be performed as desired. As shown, this process may operate as follows.

As discussed above, at 402, device under test (DUT) documentation may be received as input to one or more models 304, according to some embodiments. At 404, the one or more models may generate one or more DUT specifications (e.g., performance parameters, test case, etc.) from the DUT documentation.

At 502, the one or more models may divide the documentation into portions, according to some embodiments. For example, the portions may be pages, whole documents, paragraphs, sections, etc.

In some embodiments, the portions may be defined by topic. In other words, one model may isolate information from the documentation that relates to a same subject (e.g., to a particular specification or group of specifications). Each topic may be treated as a portion. For example, one portion may be related to a particular capability (e.g., processing speed) or operating characteristic (e.g., temperature). As one possibility, intelligent text-chunking may be used to define portions.

In some embodiments, the portions may be defined by formatting of the documentation. For example, pages or sections may become portions for purposes of the analysis.

At 504, the one or more models may iterate over portions of the document identifying any DUT specification(s) within each portion, according to some embodiments. For example, a model (e.g., an LLM) may analyze each portion to find any DUT specification(s) within the portion. This may be repeated iteratively until all of the portions have been reviewed.

In some embodiments, the iteration may be performed in parallel (e.g., the model may be called to analyze each portion of the DUT documentation in parallel). Alternatively the iteration may be performed sequentially. In the sequential case, output from one portion may be used to inform analysis of future portions (e.g., related DUT specifications may be tracked/flagged).

In some embodiments, the one or more models may also track metadata (e.g., the location(s) and/or original phrasing) of the identified specification(s). For example, location may be recorded in a page/line format and/or by recording particular words used in the DUT documentation. In the case of non-text DUT documentation, other forms of metadata may be recorded (e.g., frame number or time within a video/recording, portion of an image, etc.).

At 506, the one or more models may format the DUT specification(s), according to some embodiments. For example, the formatted specifications may describe how the DUT (e.g., a new product) needs to function. Among various possibilities, JSON string format may be used. A parser (e.g., Pydantic) may be used to perform the formatting.

At 508, the one or more models may identify any related or duplicative DUT specifications and consolidate them.

For example, if multiple generated DUT specifications are sufficiently similar (e.g., according to a similarity score threshold above a duplicate threshold, e.g., 0.99), the duplicate may be dropped.

Similarly, if multiple generated DUT specifications are related, but not the same, they may be compared for merging/consolidation, and or dropping a duplicate. For example, if one DUT specification identifies a range of acceptable values for a parameter and a related DUT specification identifies a single value, the single value may be compared to the range. As one possibility, if the single value is within the range, the single value may be dropped as a duplicate specification. Alternatively, the single value may be retained (e.g., to indicate an ideal value or similar), according to some embodiments.

It will be appreciated that the sequence shown in FIG. 5 is one of many possible examples. Different steps, combinations, or orders may be used as desired. Some examples of alternatives/modifications may include any of the following, among various possibilities.

In some instances, 508 may be performed prior to 506, e.g., reducing the effort spent on formatting, according to some embodiments.

A preliminary/rough version of 504 (and possibly 508 and/or 506) may be performed prior to 502. Accordingly, portions may be determined in view of preliminarily identified DUT specifications. Then a more thorough version of 504 may (optionally) be performed.

Tracking metadata may be omitted, particularly from a preliminary/rough version of 504, but even from a thorough version of 504.

In some instances, 508 may be included in 504. For example, as DUT specifications are identified in 504, they may be compared to previously identified specifications. Any related DUT specifications may be merged and/or duplicates may be discarded.

Iteration and repetition of any combination of 502-508 may be performed as desired. For example, successive iterations may be performed to more precisely define the DUT specifications, associated metadata, and/or portions of the documentation. Similarly, such iteration may allow for improvement in the elimination of duplicate DUT specifications and/or consolidation/merging of related DUT specifications. It will be appreciated that some of 502-508 may be omitted from some or all of the repetitions.

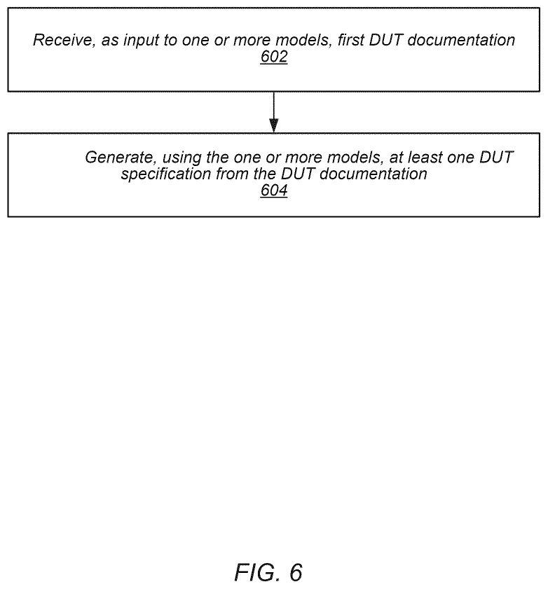

FIG. 6 illustrates a block diagram of an example of a method for generating a DUT specification, according to some embodiments. The method shown in FIG. 6 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 602, first device under test (DUT) documentation can be received as input to one or more models, e.g., such as one or more models 304. In some instances, the one or more models can be or include one or more large language models (LLMs). In some instances, the one or more models can be and/or include a generative artificial intelligence (AI) model.

At 604, at least one DUT specification may be generated from the DUT documentation using the one or more models, e.g., such as one or more models 304.

In some instances, generation of the DUT documentation may include dividing the DUT documentation into portions. The portions may be based on subject matter of the portions. The portions may be divided by text-chunking. Further, the portions may be divided by page or section according to formatting of the DUT documentation. Additionally, generation of the DUT documentation may include iteratively running one model of the one or more models on respective portions. In some instances, iteratively running one model of the one or more models on respective portions can be in parallel. In some instances, iteratively running one model of the one or more models on respective portions can be sequential.

In some instances, the at least one DUT specification can be formatted according to a JavaScript Object Notation (JSON) format.

In some instances, a first DUT specification of the at least one DUT specification can be determined to duplicate a second DUT specification of the at least one DUT specification. In such instances, the first DUT specification may be dropped. In some instances, the determination may be based on determining a similarity score for the first DUT specification in comparison to the second DUT specification and determining that the similarity score exceeds a duplicate threshold.

In some instances, a first DUT specification of the at least one DUT specification can be determined to be related to a second DUT specification of the at least one DUT specification. In such instances, the first DUT specification and the second DUT specification can be merged. In some instances, the merging can include modifying a range of values associated with the first DUT specification.

In some instances, automatic testing of a DUT according to the at least one DUT specification can be performed. Further, an update and/or refinement to the DUT documentation based on the automatic testing can be generated by the one or more models. The update and/or refinement to the DUT documentation can include broadening and/or narrowing a performance claim. In addition, the update and/or refinement to the DUT documentation can include broadening and/or narrowing an operating condition.

In some instances, the DUT documentation can include at least one of (and/or one or more of) a database including information specifying the DUT, a virtual two-dimensional model of the DUT, a virtual three-dimensional model of the DUT, a software model of the DUT, a portable document format (PDF)-based document, a spreadsheet-based document, a word processor-based document, a presentation-based document, one or more images of the DUT, one or more videos of the DUT, a diagram of the DUT, performance data associated with the DUT, programming code, an engineering format-based file or document, a schematic of the DUT, a schematic associated with the DUT, a layout of the DUT, a layout associated with the DUT, a design of the DUT, a design associated with the DUT, a bill of materials (BOM) associated with the DUT, emails associated with and/or referring to the DUT and/or an aspect of the DUT, a chat transcript associated with and/or referring to the DUT and/or an aspect of the DUT, an audio recording associated with and/or referring to the DUT and/or an aspect of the DUT, and/or a video recording associated with and/or referring to the DUT and/or an aspect of the DUT.

In some instances, the at least one DUT specification can be presented to an end user.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
receiving, as input to one or more models, first device under test (DUT) documentation; and
generating, using the one or more models, at least one DUT specification from the DUT documentation.

2. The method of claim 1,
wherein said generating comprises dividing the DUT documentation into portions.

3. The method of claim 2,
wherein the portions are based on subject matter of the portions.

4. The method of claim 2,
wherein the portions are divided by text-chunking.

5. The method of claim 2,
wherein the portions are divided by page or section according to formatting of the DUT documentation.

6. The method of claim 2,
wherein said generating comprises iteratively running one model of the one or more models on respective portions.

7. The method of claim 6,
wherein said iteratively running is in parallel.

8. The method of claim 6,
wherein said iteratively running is sequential.

9. The method of claim 1, further comprising:
formatting the at least one DUT specification according to a JavaScript Object Notation (JSON) format.

10. A non-transitory computer-readable memory medium storing program instructions which, when executed by a processor, are configured to cause a computing device to perform operations comprising:
receiving, as input to one or more models, first device under test (DUT) documentation; and
generating, using the one or more models, at least one DUT specification from the DUT documentation.

11. The non-transitory computer readable memory medium of claim 10,
wherein the program instructions are further executable the processor to cause the computing device to perform operations comprising:
determining that a first DUT specification of the at least one DUT specification duplicates a second DUT specification of the at least one DUT specification; and
in response to the determination, dropping the first DUT specification.

12. The non-transitory computer readable memory medium of claim 11,
wherein determining that the first DUT specification of the at least one DUT specification duplicates the second DUT specification of the at least one DUT specification is based on:
determining a similarity score for the first DUT specification in comparison to the second DUT specification; and
determining that the similarity score exceeds a duplicate threshold.

13. The non-transitory computer readable memory medium of claim 10,
wherein the program instructions are further executable the processor to cause the computing device to perform operations comprising:
determining that a first DUT specification of the at least one DUT specification is related to a second DUT specification of the at least one DUT specification; and
in response to the determination, merging the first DUT specification and the second DUT specification.

14. The non-transitory computer readable memory medium of claim 13,
wherein merging the first DUT specification and the second DUT specification comprises modifying a range of values associated with the first DUT specification.

15. The non-transitory computer readable memory medium of claim 10,
wherein the program instructions are further executable the processor to cause the computing device to perform operations comprising:
presenting the at least one DUT specification to an end user.

16. An apparatus, comprising:
a memory; and
at least one processor in communication with the memory and configured to perform operations comprising:
receiving, as input to one or more models, first device under test (DUT) documentation; and
generating, using the one or more models, at least one DUT specification from the DUT documentation.

17. The apparatus of claim 16,
wherein the at least one processor is further configured to perform operations comprising:
performing automatic testing of a DUT according to the at least one DUT specification.

18. The apparatus of claim 17,
wherein the at least one processor is further configured to perform operations comprising
generating, by the one or more models, an update or refinement to the DUT documentation based on the automatic testing.

19. The apparatus of claim 18,
wherein the update or refinement to the DUT documentation includes broadening or narrowing a performance claim.

20. The apparatus of claim 18,
wherein the update or refinement to the DUT documentation includes broadening or narrowing an operating condition.
